(19) United States
(12) Patent Application Publication
(10) Pub. No.: US 2010/0232064 A1
(43) Pub. Date: Sep. 16, 2010

(54) HARD DISK DRIVE

(75) Inventors: Hong Taek LIM, Suwon-si (KR); Youn Tai Kim, Hwasung-si (KR); Byoung Gyou Choi, Suwon-si (KR); Jung Hyeon Kim, Hwasung-si (KR); Jae-Bum Kim, Suwon-si (KR); Seung-Cheol Yang, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/724,658

(22) Filed: Mar. 16, 2010

(30) Foreign Application Priority Data
Mar. 16, 2009 (KR) 2009-0021993

(51) Int. Cl. G11B 5/10

(52) U.S. Cl. 360/129; G9B/5.034

(57) ABSTRACT

A hard disk drive, in which a flexible printed circuit board (FPC) bracket is readily assembled and sealed to a base together with a gasket header even though a screw or a sealing tape that involves a screw driver or other assembling tools is not used, or a boss of the base is not tapped.

### CROSS-REFERENCE TO RELATED APPLICATIONS

This application claims the benefit of priority under 35 U.S.C. §119(a) Korean Patent Application No. 10-2009-0021993 filed on Mar. 16, 2009, in the Korean Intellectual Property Office, the disclosure of which is incorporated herein by reference in its entirety.

### BACKGROUND

1. Field of the Invention

The present general inventive concept relates to an auxiliary memory unit of a computer system, and more particularly, to a hard disk drive where a flexible printed circuit bracket is easily assembled and sealed to a base.

2. Description of the Related Art

A hard disk drive (HDD) that has been widely used as an auxiliary memory unit of a computer system or the like includes a head stack assembly (HSA) having a magnetic head in a base thereof.

The HSA allows the magnetic head to record data on the disk or to reproduce the recorded data while rotating toward a disk with respect to a pivot shaft. The data is transmitted from the magnetic head to a printed circuit board assembly (PCBA) assembled to a lower part of the base via a flexible printed circuit (FPC).

Meanwhile, the FPC provided for transmitting the data has both ends connected to the HSA and the PCBA, respectively, and an FPC bracket is assembled to one side of the base so that the FPC can be connected to the PCBA.

In brief, a through portion that penetrates the base is formed on a plate surface of the base, and a plurality of bosses internally tapped to have a screw fastening hole to which a screw is fastened is formed around the through portion. Further, a gasket header is provided in a region of the through portion so that air leakage to the through portion can be prevented before assembling the FPC bracket.

Thus, to assemble the FPC bracket to the region of the through portion of the base, the gasket header is first placed in the region of the through portion and the PFC bracket is put on the gasket header. Then, a plurality of screws are inserted in through holes formed in the FPC bracket by a tool such as a screw driver, respectively, and thus fastened to the screw fastening holes of the base via the gasket header. From the bottom of the base, a sealing tape is attached to and finally seals up the region of the screw fastening hole.

However, in a conventional hard disk drive with the above-described structure and assembling process, a general screw is used as a means for assembling the FPC bracket, the sealing tape has to be additionally used upon completion of the assembling, and the boss of the base should be tapped for forming not a simple hole but the screw fastening hole. Therefore, the number of component parts and the number of processing operations are generally increased and thus cause a product cost to be increased. Further, it takes much time and effort to undergo many assembling processes, thereby increasing work effort.

Furthermore, if the conventional hard disk drive has an unexpected fault in fastening the screw, particles may be generated therein and thus lead to a problem in reliability of the hard disk drive. Accordingly, there is required an improved structure for assembling the FPC bracket.

### SUMMARY OF THE INVENTION

The present general inventive concept provides a hard disk drive in which a flexible printed circuit board (FPC) bracket can be readily assembled and sealed to a base without using a screw or a sealing tape that involves a screw driver or other assembling tools, and without tapping a boss of the base, thereby decreasing a number of component parts and work effort and providing convenience in assembling the FPC.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by a hard disk drive including a flexible printed circuit (FPC) bracket provided to connect an FPC to a printed circuit board assembly (PCBA) and formed with a plurality of first through holes thereon, a base including a first through portion through which a surface of the FPC bracket is exposed toward the PCBA, and a plurality of base holes formed at positions to correspond to the first through holes, a gasket header interposed between the base and the FPC bracket and formed with a plurality of second through holes at positions to correspond to the first through holes, and at least one sealing assembling unit inserted in the first through hole of the FPC bracket and fastened to the base hole via the second through hole of the gasket header to assemble the FPC bracket to the base while sealing up a region of the base hole.

The sealing assembling unit may include a shaft formed lengthwise in a direction that the FPC bracket is assembled to the base, a head part formed in one end part of the shaft, and being larger than a diameter of the shaft to be in contact with and supported on a top surface of the FPC bracket when the FPC bracket is assembled to the base, a holding part formed in the other end part of the shaft, and being larger than the diameter of the shaft to be in contact with and supported on a bottom surface of a boss when the FPC bracket is assembled to the base, and at least one sealing wing part outwardly extended from the shaft in a radial direction to seal up the region of the base hole.

The at least one sealing assembling unit may include a plurality of sealing assembling units arranged to be spaced apart from each other, and made of an elastic material having elasticity to be partially compressed and expanded.

The sealing assembling unit may be made of at least two materials different in a property of matter from each other by co-injection molding.

The holding part and the head part may be made of elastomer, and the sealing wing part may be made of a solid form whose air permeability becomes substantially zero when receiving predetermined compression.

The sealing assembling unit may further include a compression space formed in the shaft so that the holding part or the shaft can be inwardly compressed in a radial direction when the sealing assembling unit is separated.

The holding part may be formed to have a diameter so that a value calculated as the diameter of the holding part divided by a diameter of the base hole ranges from 1 to 2, and the head part may have a diameter larger than the diameters of the holding part and the first through hole.

The at least one sealing wing part may include a plurality of sealing wing parts spaced apart from each other along a lengthwise direction of the shaft, and the sealing wing part may be formed as an umbrella type so that an exposed end part thereof can face toward the head part.

The sealing assembling unit may be provided as an independent component part separately from the FPC bracket.

The base hole may be internally formed in the boss to protrude from an inner surface of the base, and the bottom surface of the boss contacting and supporting the holding part may be higher than a bottom surface of the base.

One of the base and the gasket header may be provided with at least one first projection to protrude toward the other one and to set an assembling direction between the base and the gasket header, and the other one may be formed with a first projection insertion hole in which the first projection is inserted. One of the base and the FPC bracket may be provided with at least one second projection to protrude toward the other one and to set an assembling direction between the base and the FPC bracket, and the other one may be formed with a second projection insertion hole in which the second projection is inserted.

The foregoing and/or other aspects and utilities of the general inventive concept may also be achieved by a hard disk drive having a flexible printed circuit (FPC) to transmit data to a printed circuit board (PCB), including a base formed with a plurality of base holes, a bracket to connect the FPC to the PCB and formed with a plurality of through holes to correspond to the plurality of base holes, and a fastener to be received by the through holes and base holes to securely fasten the bracket to the base and seal the base holes.

The fastener includes a shaft having a head part formed at an upper end of the shaft and a holding part formed at a lower end of the shaft.

The fastener further includes at least one flexible seal member to extend from a side of the shaft and expand within the base holes to seal up the base holes when the fastener is inserted therein.

The shaft is formed with a compression space formed therein such that when the fastener is compressed in a radial direction, the fastener can be removed from the bracket and the base.

The fastener can be securely fastened to and seal up the base hole with use of only a user's hand.

The fastener extends from the bracket to the base when the fastener securely fastens the bracket to the base.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is an exploded perspective view of a hard disk drive according to an embodiment of the present general inventive concept;

FIG. 2 is an enlarged perspective view of a region of a flexible printed circuit (FPC) bracket in FIG. 1;

FIG. 3 is a rear perspective view of FIG. 2;

FIG. 4 is a partial exploded perspective view of FIG. 2;

FIGS. 5 and 6 are perspective views of a sealing assembling unit at different angles, respectively, according to an embodiment of the present general inventive concept;

FIG. 7 is a cut-open section exploded perspective view taken along line A-A of FIG. 2;

FIG. 8 is an assembled section view of FIG. 7;

FIG. 9 is a cut-open section perspective view corresponding to FIG. 8;

FIGS. 10A and 10B are views of the sealing assembling unit according to alternate embodiments of the present general inventive concept; and

FIG. 11 is a cut-open section perspective view of an FPC bracket according to an alternative embodiment of the present inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

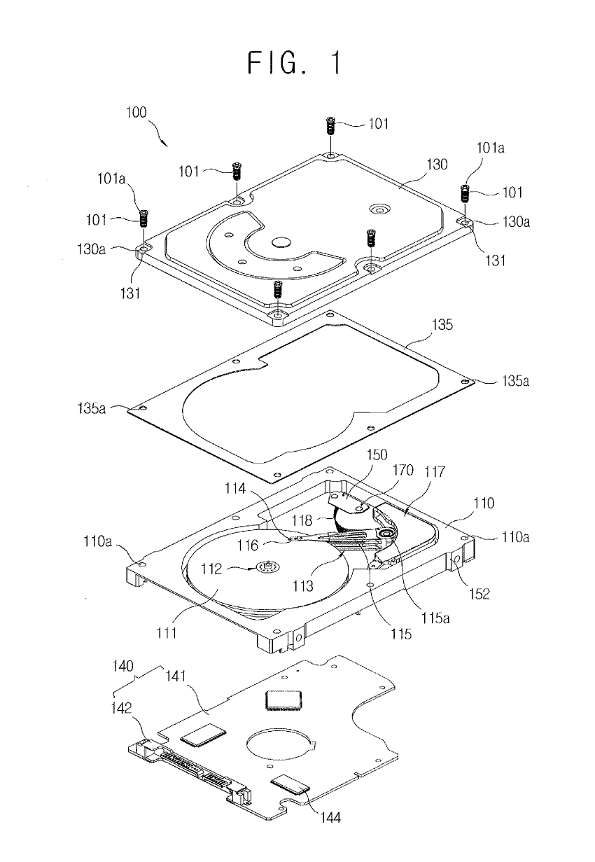

FIG. 1 is an exploded perspective view of a hard disk drive according to an embodiment of the present general inventive concept.

As shown in FIG. 1, a hard disk drive 100 includes a base 110 internally provided with a plurality of interior component parts (not shown) to read and write information, a cover 130 placed over the base 110 with the interior component parts therebetween and assembled to the base 110, a gasket 135 interposed between the cover 130 and the base 110 and sealing up the cover 130 and the base 110, and a printed circuit board assembly (PCBA) 140 coupled to a bottom of the base 110.

The base 110 is a part to which the plurality of interior component parts is mounted. That is, the interior component parts such as at least one disk 111 to record data, a spindle motor 112 provided in a center region of the disk 111 and to rotate the disk 111, and a head stack assembly (HSA) 113 relatively moving toward the disk 111 are mounted to the base 110.

The base 110 is classified into a flat type where the interior component parts are put on a flat top surface thereof and assembled, and a bowl type where the interior component parts are accommodated therein and assembled.

The embodiment as described in FIG. 1 employs the bowl type base 110, but is not limited thereto. Alternatively, the present general inventive concept may be applied to a flat type base (not shown).

The hard disk drive 100 in the embodiment as described in FIG. 1 is a small form factor hard disk drive (SFF HDD) where the disk 111 having a diameter of 1.8 inch is applied, but not limited thereto. Alternatively, the present general inventive concept can be applied to all hard disk drives regardless of large, small and medium forms.

As one of the interior component parts, the HSA 113 includes a magnetic head 114 to record and load data on the disk 111, and an actuator 115 to fly the magnetic head 114 so that the magnetic head 114 can access the data on the disk 111.

The magnetic head 114 is provided at a front end of a head gimbal 116 extended from and connected to the actuator 115. The magnetic head 114 flies while keeping a minute gap from the surface of the disk 111 by rising up due to an air current on the surface of the disk 111 generated as the plurality of disks 111 rotates at high speed.

The actuator 115 is provided with respect to a pivot shaft 115a and rotatable relative to the disk 111. That is, the actuator 115 moves left and right by operations of a voice coil motor (VCM) 117 provided at one side end thereof, so that the magnetic head 114 provided at the other side end can record or read data in or from a track on the disk 111 while moving in a radial direction on the disk 111.

Although not shown in the drawings, a latch may be placed under the voice coil motor 117 so as to elastically support the actuator 115 and prevent the actuator 115 from voluntarily moving when the magnetic head 114 is parked on a parking zone (not shown) of the disk 111. If a support such as, for example, a separate ramp is provided, the magnetic head 114 may be parked in the ramp. In this embodiment, a parking area is excluded from the disk 111.

The cover 130 covers a top surface of the base 110 and protects the plurality of interior component parts.

The cover 130 may be made of metal. For example, the cover 130 may be made by die-casting aluminum alloy or pressing steel.

The cover 130 is assembled to the base 110 by a plurality of screws 101, e.g., by six screws 101 as shown in the embodiment in FIG. 1. Also, the cover 130 is formed with a recess 131 where a head 101a of the screw 101 is placed.

Further, the gasket 135 is provided to seal up an assembled surface between the cover 130 and the base 110 when the cover 130 and the base 110 are assembled by the screw 101. The gasket 135 is made of rubber, which forms a continuous closed loop along a circumference on the top surface of the base 110 as long as the gasket 135 does not interfere with the interior component parts.

Thus, the gasket 135 and the cover 130 are sequentially put on the top surface of the base 130. Then, the screws 101 are inserted in holes 130a of the cover 130 and holes 135a of the gasket 135 and fastened to the screw grooves 110a of the base 110, thereby being assembled into the hard disk drive 100.

The PCBA 140 is coupled to a bottom of the base 110. The PCBA 140 includes a printed circuit board (PCB) 141 mounted with a plurality of circuit elements, and a connector 142 coupled to one side of the PCB 141.

The PCB 141 includes a controller 143 that generally controls the hard disk drive 100. Further, a plurality of memories 144 to store various data, tables or the like is provided around the controller 143.

Meanwhile, as described above, the HSA 113 is rotated toward the disk 111 and makes the magnetic head 114 record data on the disk 111 or load the recorded data from the disk 111. At this time, the data is transmitted to the PCBA 140 coupled to the bottom of the base 110 via a flexible printed circuit (FPC) 118.

Thus, both ends of the FPC 118 have to be connected to the HSA 113 and the PCBA 140, respectively. To connect the FPC 118 with the PCBA 140, there are provided an FPC bracket 150, a gasket header 160, and a sealing assembling unit 170.

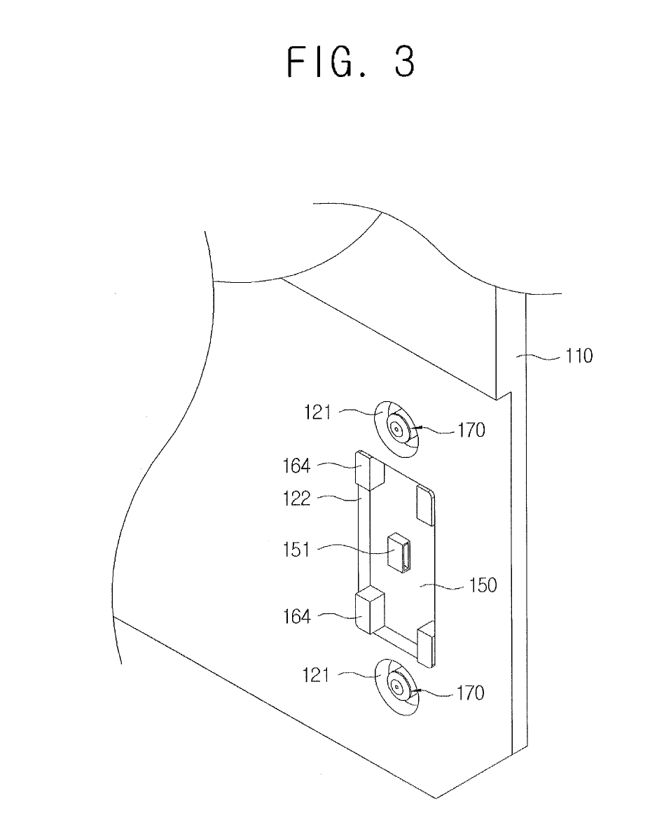

In the case that the FPC 118 is connected to the FPC bracket 150, a terminal 151 (refer to FIG. 3) formed on a rear surface of the FPC bracket 150 may be electrically connected to the PCBA 140 by a separate cable, but is not limited thereto. Below, an assembling structure of the FPC bracket 150 to the base 110 will be described.

There has been disclosed a conventional assembling structure of an FPC bracket. However, contrary to the present general inventive concept, the conventional assembling structure employs a general screw (not shown) and may also employ a sealing tape upon finishing the assembling. Also, in the conventional assembling structure, a boss of a base of the hard disk drive has to be tapped to form not a simple hole but a screw fastening hole (not shown). Therefore, the number of component parts and the number of processing operations are generally increased, thereby increasing product cost. Further, it takes much time and effort to undergo many assembling processes, thereby increasing work effort.

Furthermore, if the conventional assembling structure has an unexpected fault in fastening the screw, particles may be generated therein, and thus lead to a problem in reliability of the hard disk drive.

Accordingly, the present general inventive concept provides the following structure to solve the foregoing problems of the conventional structure.

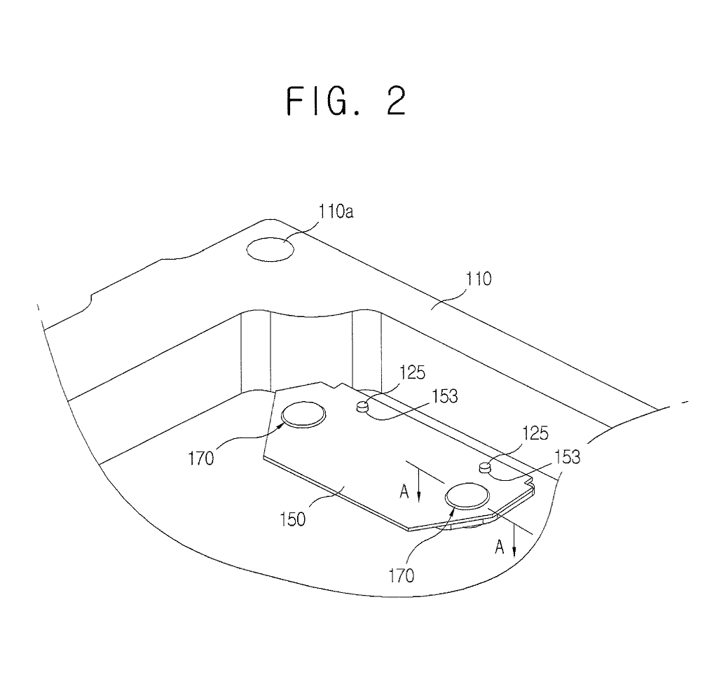

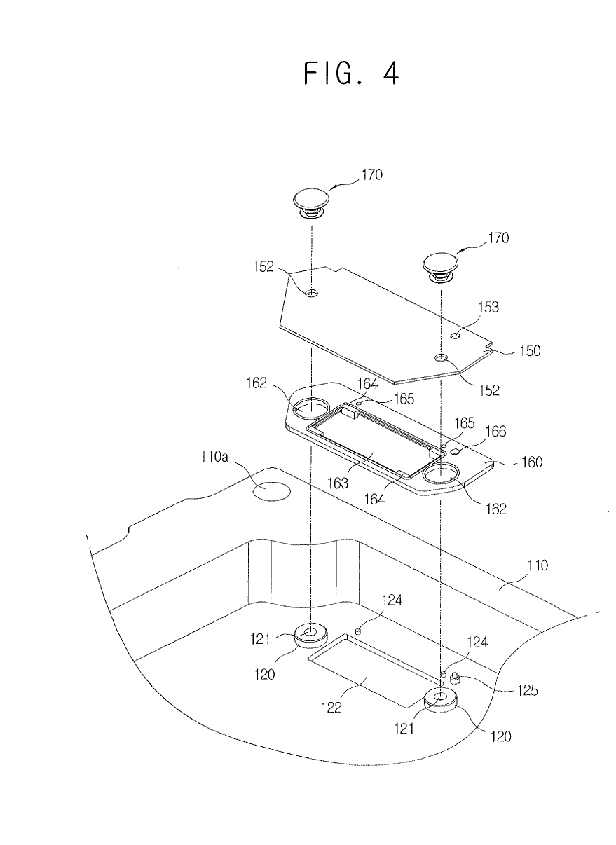

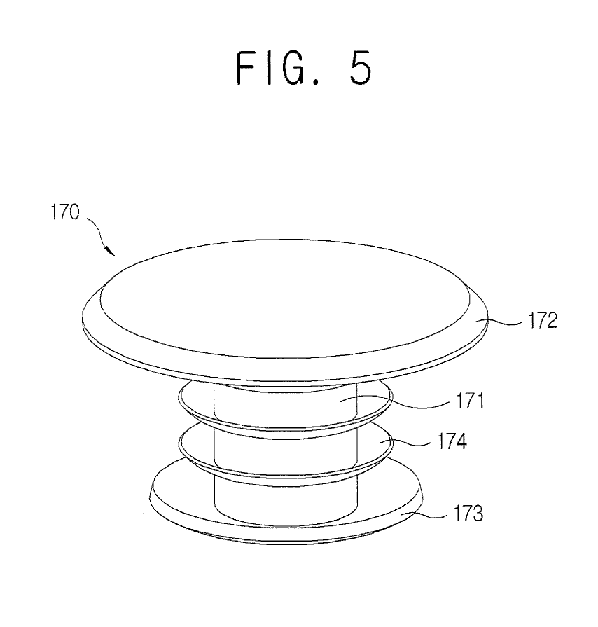

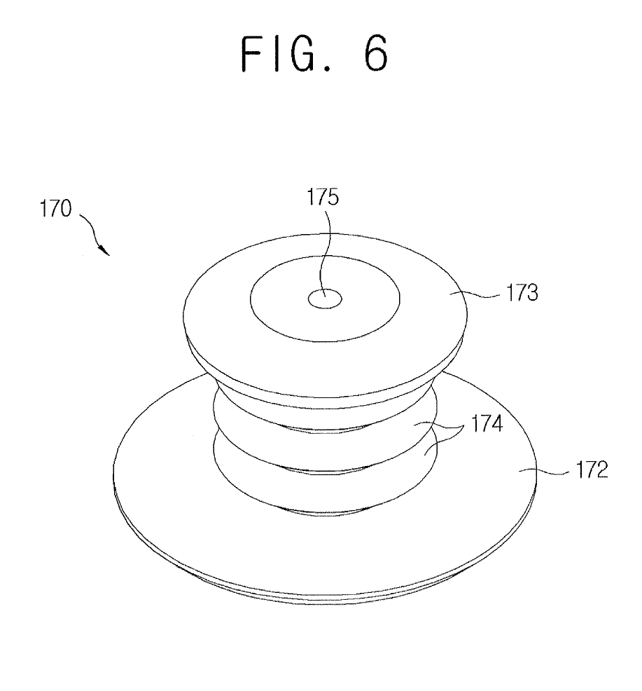

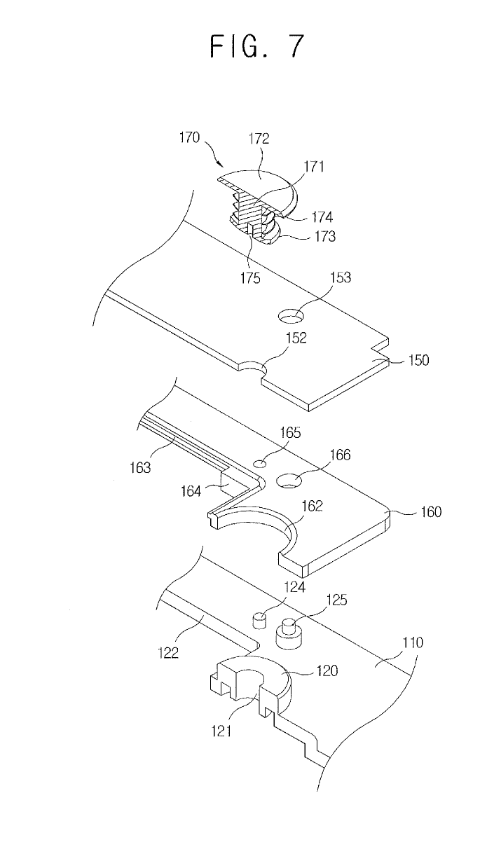

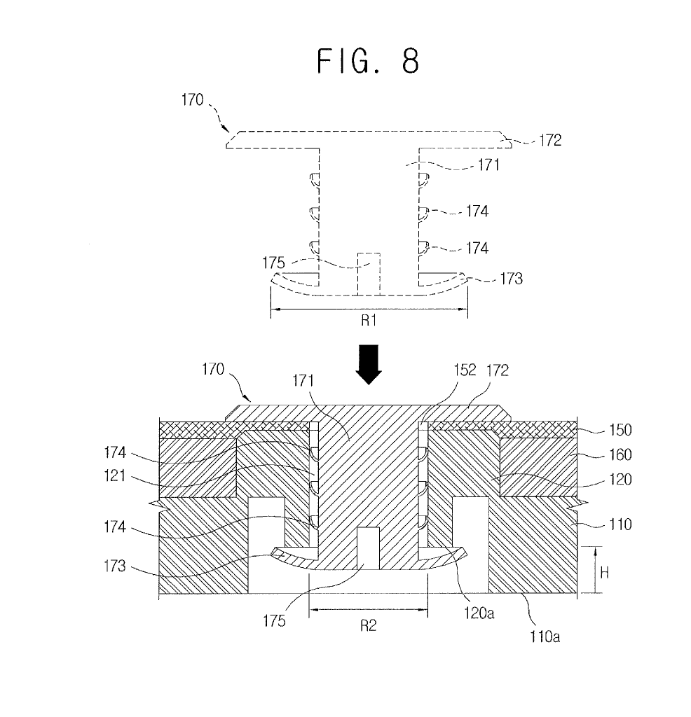

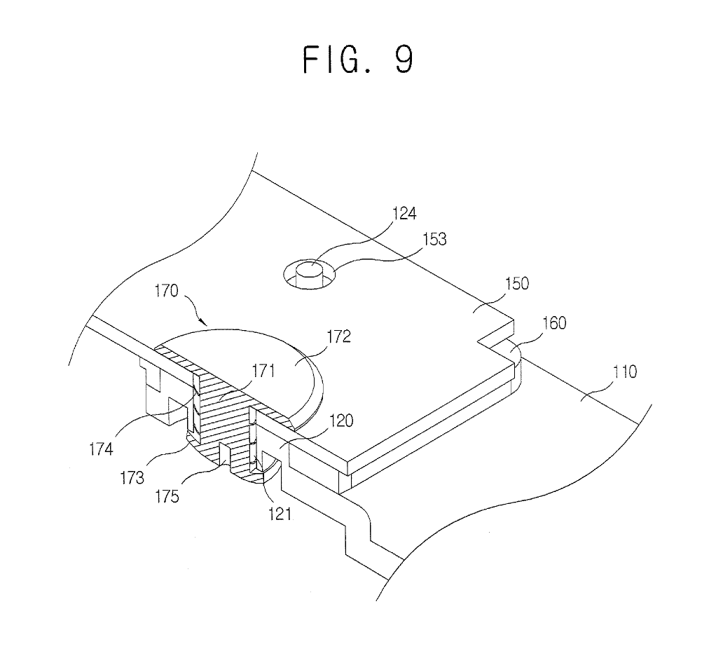

FIG. 2 is an enlarged perspective view of a region of the FPC bracket in FIG. 1, FIG. 3 is a rear perspective view of FIG. 2, FIG. 4 is a partial exploded perspective view of FIG. 2, FIGS. 5 and 6 are perspective views of a sealing assembling unit at different angles, respectively, FIG. 7 is a cut-open section exploded perspective view taken along line A-A of FIG. 2, FIG. 8 is an assembled section view of FIG. 7, and FIG. 9 is a cut-open section perspective view corresponding to FIG. 8.

According to an embodiment of the present general inventive concept, the FPC bracket 150, the gasket header 160, and the sealing assembling unit 170 are provided for the connection of the FPC 118 (refer to FIG. 1). A structure of the base 110 will be described below.

Referring to FIG. 4, the base 110 includes two bosses 120 internally formed with base holes 121. The two bosses 120 are places to which two sealing assembling units 170 are coupled. The two bosses 120 slightly protrude from an inner surface of the base 110. Also, the base holes 121 are formed in the bosses 120. Alternatively, the base holes 121 may be directly formed on the base 110 without forming the bosses 120.

The two bosses 120 are spaced apart from each other at a predetermined distance, and a first through portion 122 is formed therebetween. According to an embodiment of the present general inventive concept, the first through portion 122 is perforated in the form of an approximately rectangle. The first through portion 122 provides exposing a terminal 151 (refer to FIG. 3) formed on a rear surface of the FPC bracket 150 toward the PCBA 140.

Around the first through portion 122, there are provided two first projections 124 and one second projection 125. The two first projections 124 are provided to settle the gasket header 160 to a right assembling position of the base 110 when the FPC bracket 150 is assembled. The one second projection 125 is provided to settle the FPC bracket 150 to a right assembling position of the base 110.

Such an inner structure of the base 110 is used for the SFF HDD where the disk 111 having a diameter of 1.8 inch is applied like the hard disk drive 100 (refer to FIG. 1).

Accordingly, when the present general inventive concept is applied to a medium or large form hard disk drive, the number, shape, and existence of bosses 120, the shape and position of the first through portion 122, and the number, shape, and existence of the first projections 124 and the second projection 125 may be varied correspondingly.

The FPC bracket 150 is provided to connect the FPC 118 toward the PCBA 140 coupled to the bottom of the base 110. Thus, the FPC bracket 150 is assembled to a region of the first through portion 122 of the base 110. For the assembly of the FPC bracket 150, the FPC bracket 150 is formed with two first through holes 152 to correspond to the number of bosses 120.

The gasket header 160 is interposed between the base 110 and the FPC bracket 150 and prevents air leakage to the first through portion 122.

The gasket header 160 is formed with a plurality of second through holes 162 positioned to correspond to the first through holes 152 of the FPC bracket 150. The second through holes 162 are formed to be larger than the first through holes 152 since the second through holes are not an actual coupled or assembled part. According to an embodiment of the present general inventive concept, each second through hole 162 has a size such that the second through hole 162 is configured to circle around an outer surface of the boss 120 formed on the base 110.

In a center region of the gasket header 160 is formed a second through portion 163 to have a size corresponding to the first through portion 122 of the base 110. The second through portion 163 is internally formed with a rib 164 that comes into contact with and is inserted in an inner surface of the first through portion 122 when the gasket header 160 is disposed and put on the base 110. The rib 164 fits the gasket header 160 to the base 110 and assists in preventing the air leakage toward the first through portion 122.

According to an embodiment of the present general inventive concept, a total of four ribs 164 are respectively provided at inside corner areas of the second through portion 163, but is not limited thereto. Alternatively, the rib 164 may be provided in the form of a continuous band along the inner circumference of the second through portion 163.

If the gasket header 160 is disposed at the assembling position of the base 110, the ribs 164 of the gasket header 160 are in contact with and fitted to an inner surface of the first through portion 122, and the second through holes 162 of the gasket header 160 are placed around the outer surface of the respective boss 120, so that the gasket header 160 can be arranged in the right assembling position of the base 110.

However, according to an embodiment of the present general inventive concept, the plurality of first projections 124 and the plurality of second projection insertion holes 165 are additionally formed as an auxiliary means to set an assembling direction between the base 110 and the gasket header 160. The plurality of first projections 124 is formed on the base 110, and the plurality of second projection insertion holes 165 is formed on the gasket header 160. As the first projections 124 of the base 110 are inserted in the second projection insertion holes 165 of the gasket header 160, the assembling direction of the gasket header 160 can be easily set with respect to the base 110.

Likewise, to set the assembling direction of the FPC bracket 150 with respect to the base 110, the hard disk drive 100 according to an embodiment of the present general inventive concept further includes the second projection 125 and a second projection insertion hole 153.

The second projection 125 is formed on the base 110, and the second projection insertion hole 153 is formed on the FPC bracket 150. As the second projection 125 of the base 110 is inserted in the second projection insertion hole 153 of the FPC bracket 150, the assembling direction of the FPC bracket 150 can be easily set with regard to the base 110.

Since the gasket header 160 is interposed between the base 110 and the FPC bracket 150, the second projection 125 of the base 110 passes through a through hole 166 formed on the gasket header 160 and is then inserted in the second projection insertion hole 153 of the FPC bracket 150.

Meanwhile, the sealing assembling unit 170 couples the FPC bracket 150 to the base 110 while sealing up a region of the base hole 121. That is, the sealing assembling unit 170 not only assembles the FPC bracket 150 to the base 110, but also seals up the region of the base hole 121.

According to an embodiment of the present general inventive concept, two sealing assembling units 170 are employed and may be provided separately from the FPC bracket 150. After the gasket header 160 and the FPC bracket 150 are arranged on the top surface of the base 110, the sealing assembling units 170 are inserted in the first through holes 152 of the FPC bracket 150 and fastened to the base hole 121 via the second through holes 162 of the gasket header 160.

Each of the sealing assembling units 170 includes a shaft 171, a head part 172 formed in an upper end part of the shaft 171, a holding part 173 formed in a lower end part of the shaft 171, and a plurality of sealing wing parts 174 formed on an outer circumference of the shaft 171.

The shaft 171 is formed such that a length of the shaft 171 extends from the head part 172 to the holding part 173.

The length of the shaft 171 is configured such that the head part 172 may be in contact with and supported on a top surface of the FPC bracket 150, and a holding part 173 may be in contact with and supported on a bottom surface of the respective boss 120.

The head part 172 is formed on an upper end part of the shaft 171 and may be larger than a diameter of the shaft 171, thereby being in contact with and supported on the top surface of the FPC bracket 150 when the FPC bracket 150 is assembled to the base 110.

Thus, the head part 172 is formed to have a diameter larger than at least the diameter of the respective first through hole 152 formed on the FPC bracket 150. According to an embodiment of the present general inventive concept, the diameter of the head part 172 is formed to be larger than a diameter of the holding part 173, but is not limited thereto.

The holding part 173 is formed on the other end part of the shaft 171 and is larger than the diameter of the shaft 171, thereby being in contact with and supported on a respective bottom surface 120a (refer to FIG. 8) of the respective boss 120 when the FPC bracket 150 is assembled to the base 110.

An embodiment of the present general inventive concept will be described below with reference to FIG. 8.

As shown in FIG. 8, according to this embodiment of the present general inventive concept, the bottom surface 120a of the boss 120 is disposed at a position H higher than that of the bottom surface 110a of the base 110 along a thickness of the base 110. Although the holding part 173 is in contact with and supported on the bottom surface 120a of the boss 120, the holding part 173 is prevented from being stuck out of the bottom surface 110a of the base 110.

As shown in FIG. 8, R1 represents the diameter of the holding part 173 and R2 represents the diameter of the base hole 121. The diameter R1 of the holding part 173 may be larger than a diameter R2 of the base hole 121. According to an embodiment of the present general inventive concept, a value calculated as a diameter R1 of the holding part 173 divided by a diameter R2 of the base hole 121 ranges from 1 to 2. In other words, the value of R1 may be equal to the value of R2 (R1=R2), or twice the size of R2 (R1=2×R2).

As such, if the sealing assembling unit 170 is fastened in the base hole 121, the head part 172 is in contact with and supported on the top surface of the FPC bracket 150, and the holding part 173 is in contact with and supported on the bottom surface 120a of the boss 120, so that the FPC bracket 150 can be assembled to the base 110 together with the gasket header 160.

Meanwhile, if the sealing assembling unit 170 includes only the shaft 171, the head part 172 and the holding part 173, a region of the base hole 121 is not sealed up and air leakage may occur in this region even though the FPC bracket 150 can be assembled to the base 110 together with the gasket header 160. To prevent such an air leakage, the sealing assembling unit 170 is additionally provided with the plurality of sealing wing parts 174.

The plurality of sealing wing parts 174 outwardly extends from the shaft 171 in a radial direction, and seals up the region of the base hole 121.

According to an embodiment of the present general inventive concept, three sealing wing parts 174 spaced apart from each other are disclosed, but is not limited thereto. Alternatively, one, two or more than four sealing wing parts 174 may be provided.

As shown in FIG. 8, the sealing wing parts 174 serve to seal up the region of the base hole 121. Therefore, the sealing wing parts 174 are preferably made of an elastic material rather than a hard and solid metallic material.

In other words, the sealing assembling unit 170 according to an embodiment of the present general inventive concept is made of an elastic material having elasticity to be partially compressed and expanded so that the sealing assembling unit 170 can be assembled as being pressed with a worker's hand without a separate tool. For example, the sealing assembling unit 170 may be a fastener or tool-free sealing assembling device to seal the base hole 121. As such, the fastener or tool-free sealing assembling device may be used to securely fasten the FPC bracket 150 to the base 110 to prevent leakage of air in the region of the base hole 121.

For example, the sealing assembling unit 170 can be made of material, such as rubber, silicon, urethane, or the like. However, the sealing assembling unit 170 may play two roles of assembling and sealing at the same time, and is therefore made of at least two elastic materials having a different property of matter from each other. As such, since the sealing assembling unit 170 is made of different elastic materials, the sealing assembling unit 170 may be manufactured by a co-injection molding method.

For example, the holding part 173 and the head part 172 of the sealing assembling unit 170 may be made of an elastomer, and the sealing wing parts 174 may be made of a solid form whose air permeability becomes substantially zero when receiving predetermined compression. Further, the shaft 171 may be made of the same material as the holding part 173 and the head part 172, or the shaft 171 may be made of a metallic material. If the shaft 171 is made of the metallic material, the holding part 173, the head part 172 and the sealing wing parts 174 are formed all together by co-injection molding the elastomer and the solid form when the shaft 171 is formed by the metallic material.

Thus, the sealing wing parts 174 are made of the solid form that has certain elasticity and whose air permeability becomes zero when receiving predetermined compression, so that the base hole 121 can be sealed up by the sealing wing parts 174 when the sealing wing parts 174 are inserted in the region of the base hole 121 (refer to FIG. 8), thereby preventing the air leakage from occurring in this region. Accordingly, a conventional sealing tape is not needed.

The sealing wing parts 174 have to not only be conveniently assembled, but also have an effective sealing structure because the sealing wing parts 174 are slightly compressed when the sealing assembling unit 170 is assembled and then seals up the base hole 121 while being expanded within the base hole 121.

To this end, according to an embodiment of the present general inventive concept, the sealing wing parts 174 may be formed as an umbrella type or an elliptical type so that an exposed end part thereof can face toward the head part 172. As the sealing wing parts 174 are formed as such, not only convenience in assembling the sealing wing parts 174 to the base hole 121 is improved, but also the sealing effect becomes better.

In the meantime, to separate the FPC bracket 150 from the base 110 for reasons of maintenance or the like, the sealing assembling unit 170 is removed. However, because the diameter R1 of the holding part 173 of the sealing assembling unit 170 may be larger than the diameter R2 of the base hole 121, the sealing assembling unit 170 is not easily pulled out by simply pulling the sealing assembling unit 170. Accordingly, to more effectively pull out the sealing assembling unit 170, the sealing assembling unit 170 is additionally provided with a compression space 175.

As shown in FIG. 8, the compression space 175 provides a space where the holding part 173 or the shaft 171 can be inwardly compressed in a radial direction to separate the previously assembled sealing assembling unit 170. Thus, a worker presses the holding part 173 or the shaft 171 using the compression space 175, and removes the sealing assembling unit 170.

In accordance with the above-described configuration, an assembling method of the hard disk drive 100 will be described as follows.

First, the gasket header 160 is arranged in an assembling position of the first through portion 122 of the base 110. That is, the second through holes 162 of the gasket header 160 are placed around the outer surface of the respective boss 120 while the ribs 164 of the gasket header 160 are fitted to the inner surface of the first through portion 122. The first projections 124 of the base 110 are also inserted in the second projection insertion holes 165 of the gasket header 160. When such work is completed, the gasket header 160 is arranged at a right assembling position with respect to the base 110.

Then, the FPC bracket 150 is arranged at a right position on the gasket header 160. In this case, the second projection 125 of the base 110 passes through the through hole 166 formed on the gasket header 160, and then is inserted in the second projection insertion hole 153 of the FPC bracket 150, so that the FPC bracket 150 can be arranged at the right assembling position.

After the gasket header 160 and the FPC bracket 150 are arranged at the right assembling positions, the sealing assembling units 170 are inserted in the first through holes 152 of the FPC bracket 150 with a worker's bare hands without any separate tool, and then fastened to the base hole 121 via the second through holes 162 of the gasket header 160.

When the sealing assembling units 170 are fastened as such, the head parts 172 of the sealing assembling units 170 are in contact with and supported on the top surface of the FPC bracket 150, and the holding parts 173 are in contact with and supported on the bottom surfaces 120a of the bosses 120, thereby assembling the FPC bracket 150 to the base 110 together with the gasket header 160.

Further, the plurality of sealing wing parts 174 formed in the sealing assembling units 170 are expanded again within the base hole 121, thereby sealing up the base hole 121 after the assembly.

With this configuration, according to an embodiment of the present general inventive concept, the FPC bracket 150 can be readily assembled and sealed up to the base 110 without using a screw or a sealing tape that involves a screw driver or other assembling tools, and without tapping the boss 120 of the base 110. As such, a problem of increased product cost due to a number of increased component parts and increased work effort may be solved, and convenience in assembling may be achieved.

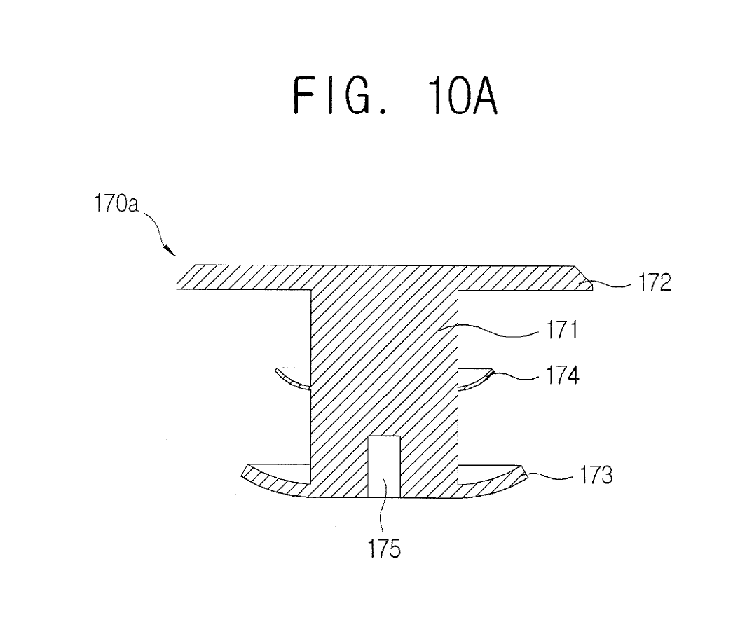

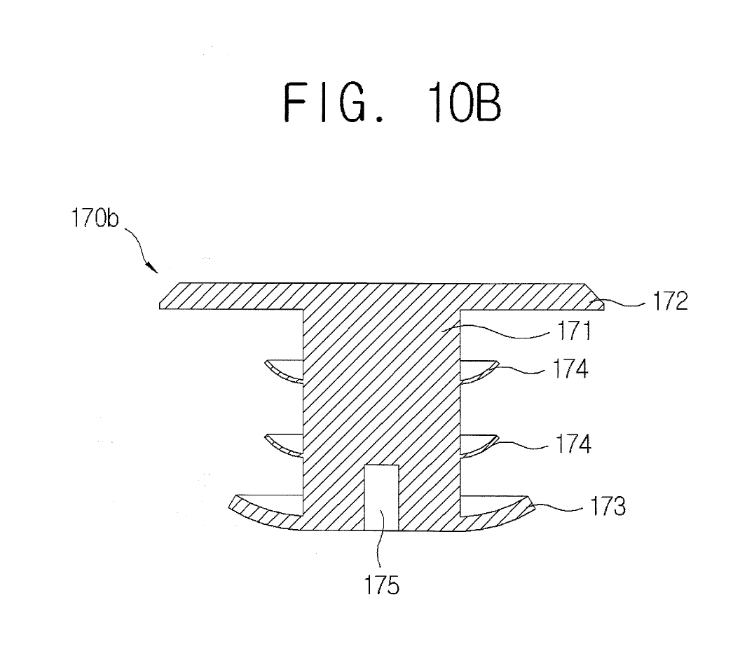

FIGS. 10A and 10B are views of the sealing assembling unit according to alternate embodiments of the present general inventive concept.

A sealing assembling unit 170a as shown in FIG. 10A is provided with a single sealing wing part 174, and a sealing assembling unit 170b as shown in FIG. 10B is provided with two sealing wing parts 174.

Although the scope of the present general inventive concept is not limited to the number of sealing wing parts 174, more sealing wing parts 174 may be advantageous for sealing up the region of the base hole 121.

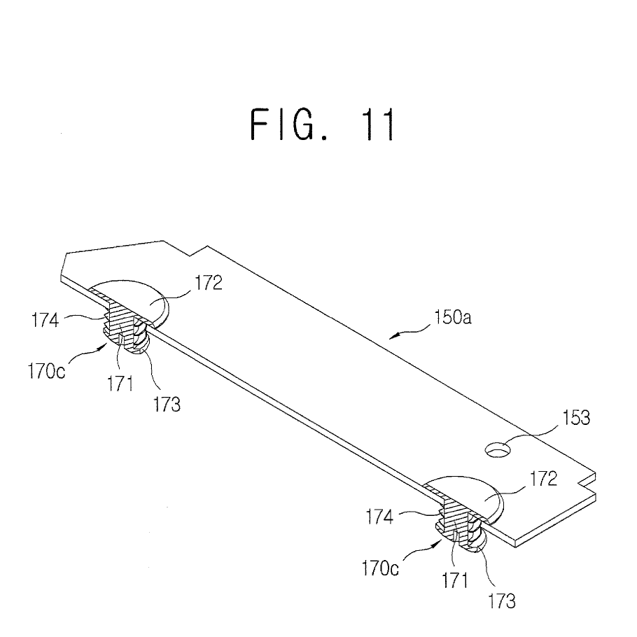

FIG. 11 is a cut-open section perspective view of an FPC bracket according to an alternative embodiment of the present general inventive concept.

In the foregoing embodiments, the sealing assembling units 170, 170a and 170b are all provided as independent component parts. However, a rivet unit 170c according to the embodiment as shown in FIG. 11 may be formed integrally with an FPC bracket 150a.

According to an embodiment of the present general inventive concept as shown in FIG. 11, work of arranging the FPC bracket 150a and work of assembling the FPC bracket 150a are substantially performed at the same time, thereby providing more convenient assembly.

As described above, according to the present general inventive concept, a flexible printed circuit board (FPC) bracket can be readily assembled and sealed to a base without using a screw or a sealing tape that involves a screw driver or other assembling tools, and without tapping a boss of the base, thereby decreasing a number of component parts and work effort and providing convenience in work.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A hard disk drive comprising:
a flexible printed circuit (FPC) bracket to connect an FPC to a printed circuit board assembly (PCBA) and formed with a plurality of first through holes thereon;
a base comprising a first through portion through which a surface of the FPC bracket is exposed toward the PCBA, and a plurality of base holes formed at positions to correspond to the first through holes;
a gasket header interposed between the base and the FPC bracket and formed with a plurality of second through holes at positions to correspond to the first through holes; and
at least one sealing assembling unit inserted in the first through hole of the FPC bracket and fastened to the base hole via the second through hole of the gasket header to assemble the FPC bracket to the base while sealing up a region of the base hole.

2. The hard disk drive according to claim 1, wherein the sealing assembling unit comprises:
a shaft formed lengthwise in a direction that the FPC bracket is assembled to the base;
a head part formed in one end part of the shaft, and being larger than a diameter of the shaft to be in contact with and supported on a top surface of the FPC bracket when the FPC bracket is assembled to the base;
a holding part formed in the other end part of the shaft, and being larger than the diameter of the shaft to be in contact with and supported on a bottom surface of a boss when the FPC bracket is assembled to the base; and
at least one sealing wing part outwardly extended from the shaft in a radial direction to seal up the region of the base hole.

3. The hard disk drive according to claim 2, wherein the at least one sealing assembling unit comprises a plurality of sealing assembling units arranged to be spaced apart from each other, and made of an elastic material having elasticity to be partially compressed and expanded.

4. The hard disk drive according to claim 3, wherein the sealing assembling unit is made of at least two materials different in a property of matter from each other by co-injection molding.

5. The hard disk drive according to claim 4, wherein:
the holding part and the head part are made of elastomer, and
the sealing wing part is made of a solid form whose air permeability becomes substantially zero when receiving predetermined compression.

6. The hard disk drive according to claim 3, wherein the sealing assembling unit further comprises a compression space formed in the shaft so that the holding part or the shaft can be inwardly compressed in a radial direction when the sealing assembling unit is separated.

7. The hard disk drive according to claim 2, wherein the holding part is formed to have a diameter so that a value calculated as the diameter of the holding part divided by a diameter of the base hole ranges from 1 to 2, and
the head part has a diameter larger than the diameters of the holding part and the first through hole.

8. The hard disk drive according to claim 2, wherein the at least one sealing wing part comprises a plurality of sealing wing parts spaced apart from each other along a lengthwise direction of the shaft, and
the sealing wing part is formed as an umbrella type so that an exposed end part thereof can face toward the head part.

9. The hard disk drive according to claim 1, wherein the sealing assembling unit is provided as an independent component part separately from the FPC bracket.

10. The hard disk drive according to claim 2, wherein the base hole is internally formed in the boss to protrude from an inner surface of the base, and
the bottom surface of the boss contacting and supporting the holding part is higher than a bottom surface of the base.

11. The hard disk drive according to claim 1, wherein:
one of the base and the gasket header is provided with at least one first projection to protrude toward the other one and to set an assembling direction between the base and the gasket header, and the other one is formed with a first projection insertion hole in which the first projection is inserted, and
one of the base and the FPC bracket is provided with at least one second projection to protrude toward the other one and to set an assembling direction between the base and the FPC bracket, and the other one is formed with a second projection insertion hole in which the second projection is inserted.

12. A hard disk drive having a flexible printed circuit (FPC) to transmit data to a printed circuit board (PCB), comprising:
a base formed with a plurality of base holes;
a bracket to connect the FPC to the PCB and formed with a plurality of through holes to correspond to the plurality of base holes; and
a fastener to be received by the through holes and base holes to securely fasten the bracket to the base and seal the base holes.

13. The hard disk drive of claim 12, wherein the fastener includes a shaft having a head part formed at an upper end of the shaft and a holding part formed at a lower end of the shaft.

14. The hard disk drive of claim 13, wherein the fastener further includes at least one flexible seal member to extend from a side of the shaft and expand within the base holes to seal up the base holes when the fastener is inserted therein.

15. The hard disk drive of claim 13, wherein the shaft is formed with a compression space formed therein such that when the fastener is compressed in a radial direction, the fastener can be removed from the bracket and the base.

16. The hard disk drive of claim 15, wherein the fastener can be securely fastened to and seal up the base hole with use of only a user's hand.

17. The hard disk drive of claim 13, wherein fastener extends from the bracket to the base when the fastener securely fastens the bracket to the base.
